(19) United States
(12) Patent Application Publication
(10) Pub. No.: US 2015/0161343 A1
(43) Pub. Date: Jun. 11, 2015

(54) Health Care Communication Systems

(71) Applicant: Vishal Mehta, Naperville, IL (US)

(72) Inventor: Vishal Mehta, Naperville, IL (US)

(21) Appl. No.: 14/559,941

(22) Filed: Dec. 4, 2014

Related U.S. Application Data
(60) Provisional application No. 61/911,635, filed on Dec. 4, 2013.

(51) Int. Cl. G06F 19/00

(52) U.S. Cl. CPC G06F 19/3418

(57) ABSTRACT

A method and system for enabling communication between a health care professional and a patient are disclosed. In an embodiment, the method includes authenticating a health care professional on the health care platform implemented in a mobile communication device and recording a memo associated with a patient by the authenticated health care professional via said health care platform, memo including health care related information associated with the patient.

### CROSS REFERENCE TO RELATED APPLICATIONS

This application claims the benefit of Provisional Patent Application No. 61/911,635 entitled “Health Care Communication System”, filed on Dec. 4, 2013, in the United States Patent and Trademark Office, incorporated herein by reference in its entirety.

### BACKGROUND

1. Technical Field

The embodiments herein generally relate to communication system, and, more particularly, method and system for a health care communication system.

2. Description of the Related Art

The lack of communication of information between health care professionals and patients is a common issue that results in poor patient compliance and low patient satisfaction. In addition, even if there is sufficient communication between a health care professional and a patient, often the accuracy of the message is lost or not properly communicated while the message is communicated to friends and family of the patient. Most often health care providers may be required to see a large number of patients in less time and as a result tend to dedicate less time and tend to pay less individual attention to each patient and hence are unable to provide customized solutions to health related issues. Additionally, episodic interactions introduce communication gaps between the patient and the health care professional.

The current available resources in health care industry are generic and consequently less engaging. For example, health care facilities, such as hospitals, may utilize many different user devices, healthcare devices, and/or healthcare systems to facilitate providing healthcare to patients, such as physician order entry systems, pharmacy information systems, hospital information systems, and the like. Additionally, healthcare devices such as infusion devices, dispensing devices, respiratory devices may be used to facilitate providing healthcare to patients. In addition, the healthcare facility may utilize user devices to facilitate with providing healthcare to patients, such as computing stations that are located throughout the health facility, personal digital assistants (PDAs) that are carried by physicians, and the like. However, communication barriers between these systems and/or devices may prevent the healthcare facility from providing efficient and effective healthcare to patients. Accordingly, there remains a need for a system for more efficient and more customized communication between health care professionals and patient.

### Summary of Embodiments of the Present Invention

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

A number of methods and systems for enabling communication between a health care professional and a patient are disclosed. In an embodiment, a system for enabling communication between a health care professional and a patient, the system includes a mobile communication device and a health care platform communicatively associated with the mobile communication device. The health care platform includes a memory and a processor, the processor includes an authentication unit, a recording unit, an identification unit, and a transmission unit. The authentication unit is configured to facilitate verifying of authentication of said health care professional. The recording unit records memo associated with a patient by the authenticated health care professional in the memory, memo including health care related information associated with the patient. The identification unit generates and assigns a unique identification code for the recorded memo. The transmission unit transmits the recorded memo along with the generated unique identification code to a communication device of the patient for providing access to the recorded memo to the patient.

In another embodiment, a health care platform implemented via a mobile communication device is provided. The health care platform includes a memory and a processor, the processor includes an authentication unit, a recording unit, an identification unit, and a transmission unit. The authentication unit is configured to facilitate verifying of authentication of said health care professional. The recording unit records a memo associated with a patient by the authenticated health care professional in the memory, the memo including health care related information associated with the patient. The identification unit generates and assigns a unique identification code for the recorded memo. The transmission unit transmits the recorded memo along with the generated unique identification code to a communication device of the patient for providing access to the recorded memo to the patient.

In yet another embodiment, a method enabling communication between a health care professional and a patient is provided. The method includes authenticating a health care professional on a health care platform implemented in a mobile communication device. The method also includes recording a memo associated with a patient by authenticated health care professional via health care platform, the memo including health care related information associated with the patient. The method further includes generating and assigning a unique identification code for the recorded memo. In an embodiment, the recorded memo is transmitted along with the generated unique identification code to a communication device of the patient for providing access to the recorded memo to the patient.

### BRIEF DESCRIPTION OF THE DRAWINGS

The embodiments herein will be better understood from the following detailed description with reference to the drawings, in which:

FIG. 1A illustrates a environment view of a system for enabling communication between a health care professional and a patient according to an embodiment herein;

FIG. 1B illustrates a block diagram depicting a system for enabling communication between a health care professional and a patient, according to an embodiment herein;

FIG. 2A exemplarily illustrates a user interface view depicted to a user of the health care platform during login into the health care platform, according to an embodiment herein;

FIG. 2B exemplarily illustrates a user interface view depicted to a user of the health care platform during authenticating login into the health care platform, according to an embodiment herein;

FIG. 2C exemplarily illustrates a user interface view depicted to a health care professional to record/access a memo according to an embodiment herein;

FIG. 2D exemplarily illustrates a user interface view depicted to a health care professional for saving a recorded memo according to an embodiment herein;

FIG. 2E exemplarily illustrates a user interface view depicted to a health care professional for confirming recoding of the memo according to an embodiment herein;

FIG. 2F exemplarily illustrates a user interface view depicted to a health care professional to view the recorded memo according to an embodiment herein;

FIG. 2G exemplarily illustrates a user interface view of a list of recording memos according to an embodiment herein;

FIG. 3A exemplarily illustrates a user interface view depicted to a patient during login into the health care platform, according to an embodiment herein;

FIG. 3B exemplarily illustrates a user interface view depicted to a patient during authenticating login into the health care platform, according to an embodiment herein;

FIG. 3C exemplarily illustrates a user interface view depicted to the patient for entering a unique identification code according to an embodiment herein;

FIG. 3D exemplarily illustrates a user interface view depicted to the patient to retrieve a memo according to an embodiment herein;

FIG. 3E exemplarily illustrates a user interface view depicted to the patient to view a list of memos according to an embodiment herein;

FIG. 3F exemplarily illustrates a user interface view depicted to a patient to play/listen to a memo according to an embodiment herein;

FIG. 3G exemplarily illustrates a user interface view depicted to a patient to share a memo with an individual according to an embodiment herein;

FIG. 3H exemplarily illustrates a user interface view depicted to a patient to agree to a disclaimer according to an embodiment herein;

FIG. 3I exemplarily illustrates a user interface view depicted to a patient to enter a individuals mail id to share a memo according to an embodiment herein;

FIG. 4 is a flow diagram illustrating a method for enabling communication between a health care professional and a patient, according to an embodiment herein;

FIG. 5 illustrates an exploded view of a receiver according to the embodiments herein; and

FIG. 6 is a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

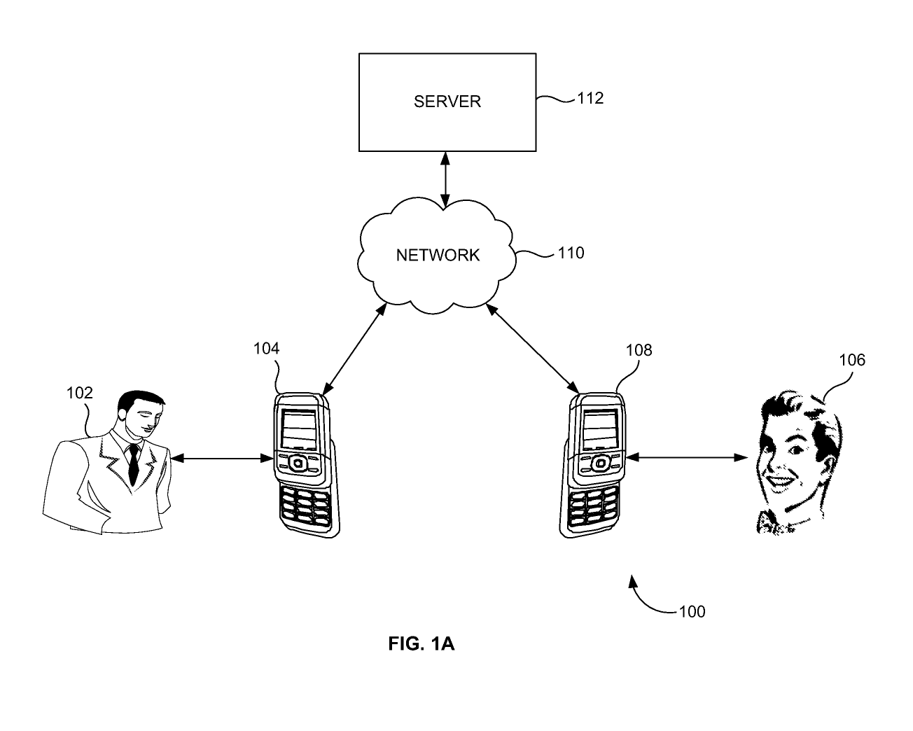

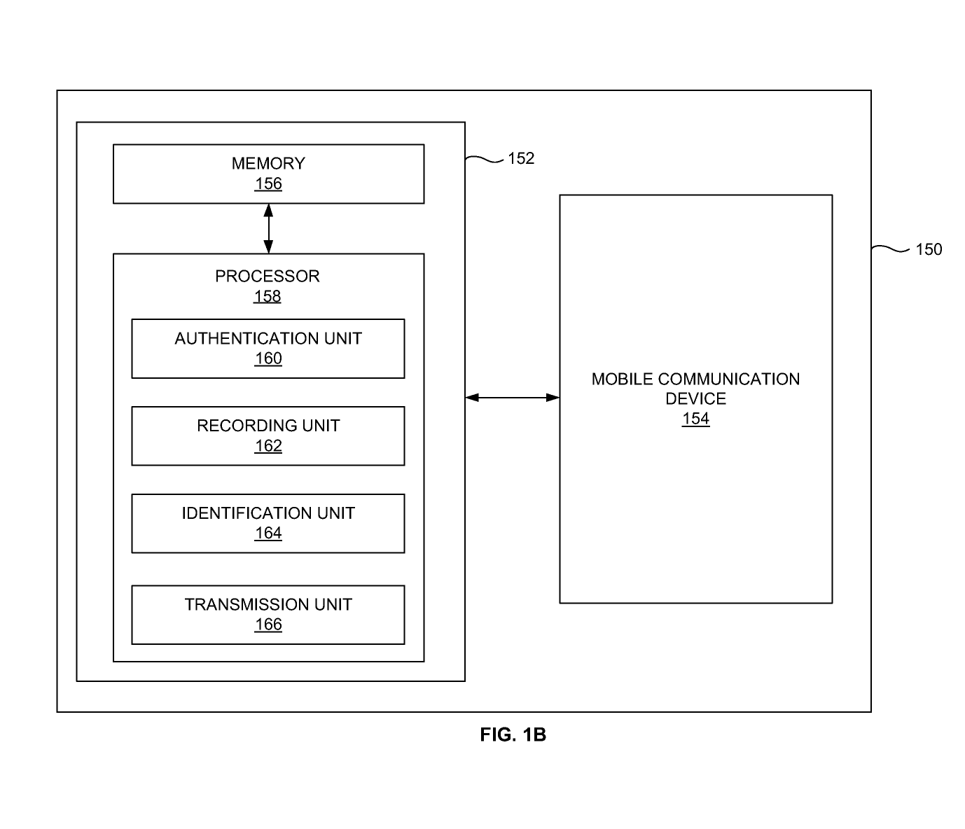

Pursuant to an exemplary scenario, there remains a need for a system for efficient communication between health care professionals and patients. The embodiments herein achieve this by providing a method and system that enables communication between the health care professionals and the patient via a health care platform. Referring now to the drawings, and more particularly to FIGS. 1 through 6, where similar reference characters denote corresponding features consistently throughout the figures, there are shown preferred embodiments.

FIG. 1A illustrates an environment view of a system for enabling communication between a health care professional and a patient according to an embodiment herein. The environment view depicts a health care professional 102, a mobile communication device 104 of the health care professional 102, a patient 106, a patient device 108, a network 110, and a server 112. The health care professional 102 interacts with the patient 106 using the mobile communication device 104 over the network 110. In one embodiment, the health care professional 102 is a doctor and/or a nurse practitioner and/or a homecare provider. Examples of the network 110 include, but is not limited to a local area network (LAN), a wide area network (WAN), a metropolitan area network, a ZigBee, a Wi-Fi network, and the like.

FIG. 1B illustrates a block diagram depicting a system 150 for enabling communication between a health care professional 102 and patient 106, according to an embodiment herein. In an embodiment, the system 150 includes a mobile communication device 154 (such as mobile communication device 104 of the health care professional 102 and a patient device 108) and a health care platform 152 communicatively associated with the mobile communication device 154. Examples of mobile communication device 154, may include, but is not limited to, a laptop, a tablet, a notebook, a mobile phone, a smart phone, and a personal computer, and the like. Although FIG. 1B depicts the health care platform 152 and the mobile communication device 154 as being separate entities, in several embodiments, the health care platform 152 may form integral part of the mobile communication device 154. In an embodiment, the health care platform 152 may be installed in the mobile communication device 154 to function as an application. In an embodiment, the health care platform 152 includes a memory 156 and a processor 158.

In an embodiment, the processor 158 includes an authentication unit 160, a recording unit 162, an identification unit 164, and a transmission unit 166. In an embodiment, the authentication unit 160 is configured to facilitate verifying of authentication of the health care professional 102. The authentication of the health care professional 102 may be enabled via a unique login information. The unique login information may include for example, a user id and password. The recording unit 162 enables the authenticated health care professional 102 to record a memo associated with the patient 108 in the memory. As used herein the term “memo” is construed as referring to data including any health care related information associated with a patient. The data may be for example, audio data or text data related to a health condition, prognosis, a post operational procedure, or any other general health related data. In an embodiment, the memo may be recorded based on a discussion of the health care professional 102 discusses with the patient 106 about one or more health related issues of the patient 108, such as health condition, prognosis, post operational procedure, medicine dosage, and the like. For example, a live conversation between the health care professional 102 and the patient 106 may be recorded and stored in the memory 156 or a memory associated with the mobile communication device. In another embodiment, the memo is recorded when the health care professional 102 is reviewing a patient file, in the presence or absence of the patient 106.

In an embodiment, the identification unit 164 generates and assigns a unique identification code for the recorded memo. The unique identification code may be used to authenticate a user of the health care platform to provide access to the recorded memo to authenticated users. In an embodiment, the patient 106 logs into the health care platform 152 as the patient 106 otherwise the patient 106 register with health care platform 152 when the patient 106 is a new user. The health care platform 152 generates and assigns the unique identification code for each memo. In an embodiment, the unique identification code may be assigned to a plurality of memos associated with one or more patients. When a patient logs into the health care platform 152, the health care platform 152 prompts the patient 106 to enter the unique identification code generated that correlates to the memo or a series of the memos that the health care professional 102 recorded from the patient 106. Alternatively, the unique identification code may be patient 106 specific so that the patient need not recall different identification codes to receive different memos.

In an embodiment, the transmission unit 166 transmits the recorded memo along with the generated unique identification code to a communication device (such as 108) of said patient 106 for providing access to the recorded memo to the patient 106. In an embodiment, the transmission may be performed immediately after recording a memo associated with a patient or may be performed by the health care professional 102 at any instance of time when intending to share the memo with the patient 106 or any other individual. The unique identification code is used to authenticate access to the recorded memo. In an embodiment, the transmission of the unique identification code may be performed in the form of a text message or an electronic mail (Email). The patient 106 is provided an access to the recorded memos upon authentication based on the unique identification code. In an embodiment, the patient 106 is authenticated via a unique login information.

The unique identification code may include, for example, a link, a code, a one-time password, and the like. Upon being authenticated, the patient 106 or the health care professional 102 is allowed to view one or more recorded memos, listen to one or more recorded memos, delete one or more recorded memos, share one or more recorded memos, or share access to one or more recorded memos. The health care platform 152 allows the patient 106 to access the recorded memos at a later time and/or electronically share the memo with other individuals, such as friends and/or family. In an embodiment, health care professional 102 is able to share the one or more recordings to the patient 106 through the network 110 using the communication system 100. In an embodiment, the health care professional 102 sends the patient 106 an email or text message with the unique identification code to notify the patient 106 that a recording of memo is available and subsequently the patient 106 may enter into the health care platform 152 to access the memos.

In an embodiment, the memo is shared or access to memo is shared in the form of an email. In an embodiment, the memo is shared or access to memo is shared in the form of a message. The system 150 allows the patient 106 to share the memos by entering one or more electronic mail ids of one or more other individuals the patient 106 intends to share the recorded memo with. In an embodiment, the system 150 allows the patient 106 to play back the recorded memos to listen or view the recorded memos.

In an embodiment, the health care platform 152 sends an alert message to individuals when a unique identification code is shared with individuals. The individuals may be allowed to access the memos associated with the unique identification code. In an embodiment, the health care platform 152 also includes a user interface configured to enable communication and discussion between the patient 106 and health care professional regarding the recorded memo. The user interface is further configured to enable communication and discussion between the patient 106 and one or more other individuals authenticated via the user to obtain access to the recorded memo. In an embodiment, the communication may be enabled via a text based messaging system. In one embodiment, the text based messaging system acts like a communication portal. The individuals who received a shared memo are also allowed to communicate with the patient 106 via the user interface. In an embodiment, the health care platform 152 enables communication and discussion between the patient 106 and the health care professional 102 regarding the recorded memo and in some embodiment, also enables communication and discussion between the patient 106 and one or more other individuals authenticated via the patient 106 to obtain access to the recorded memo.

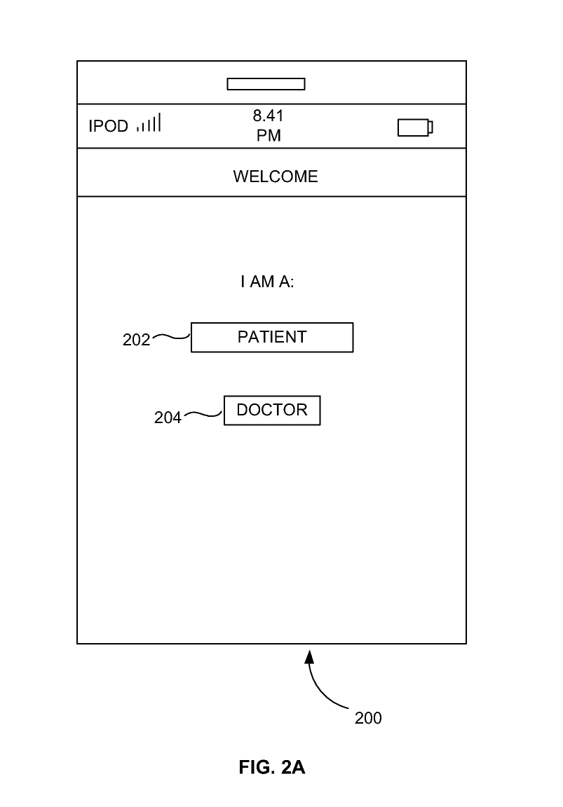

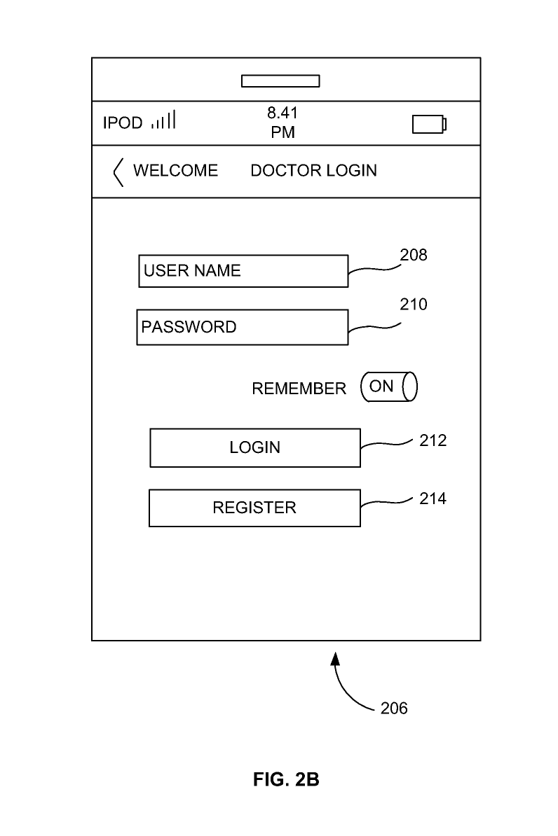

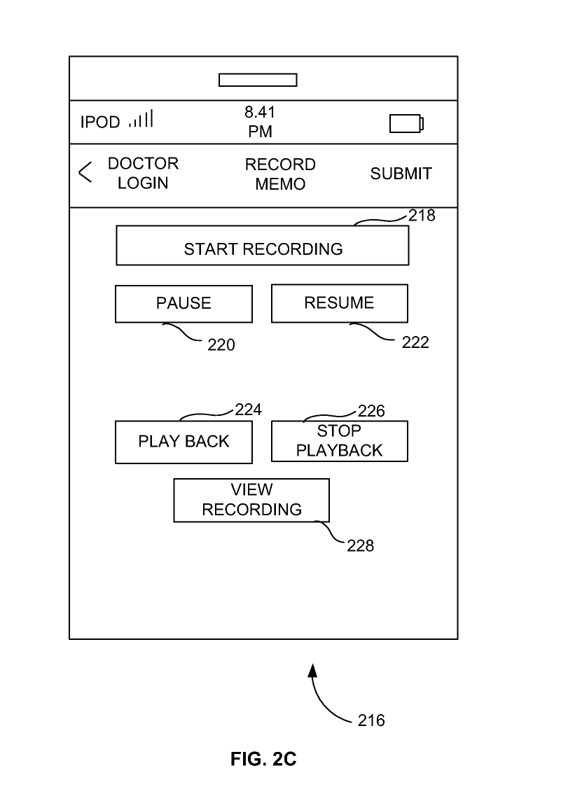

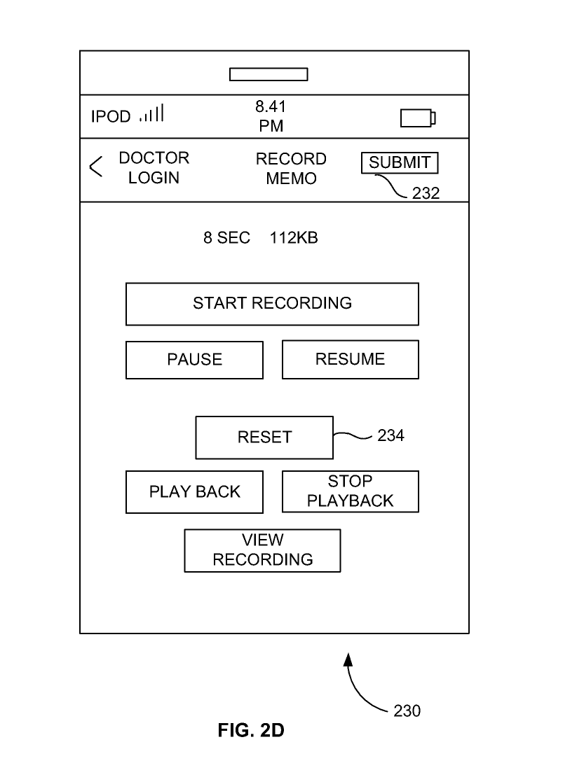

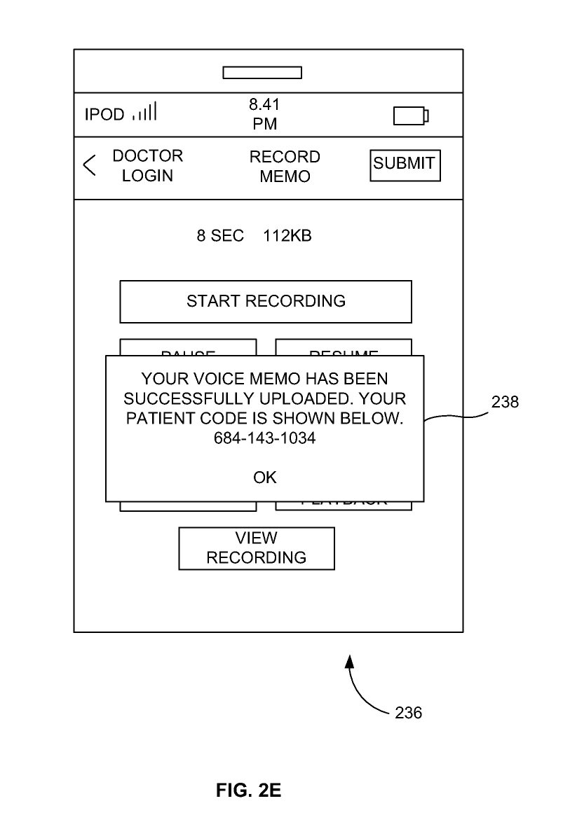

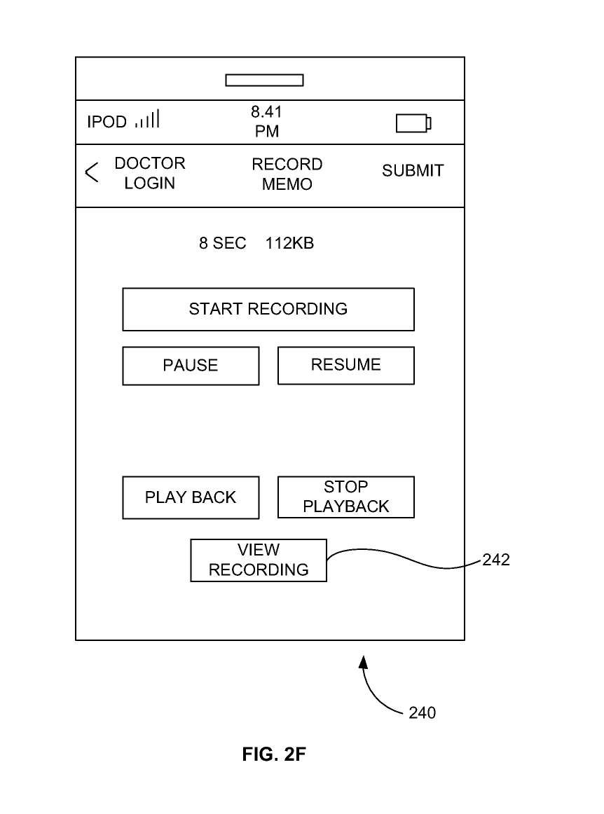

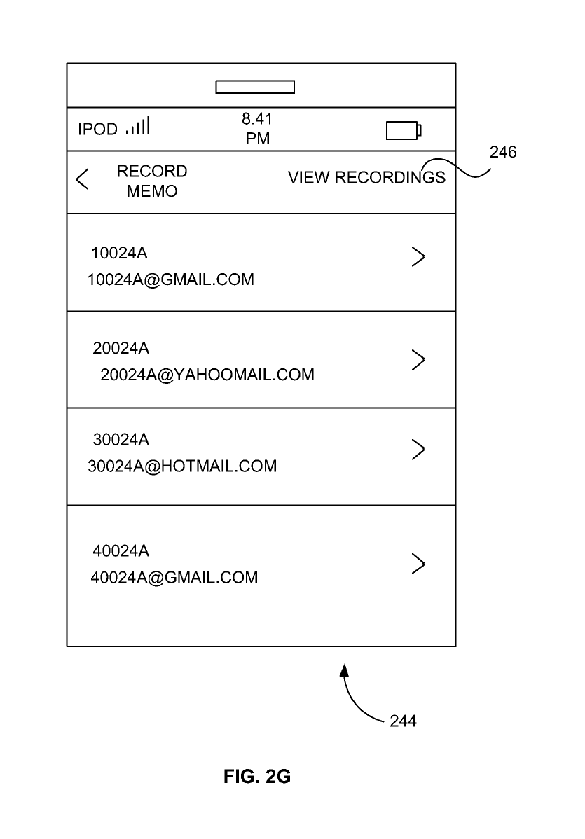

FIG. 2A exemplarily illustrates a user interface view 200 depicted to a user of the health care platform 152 during login into the health care platform 152, according to an embodiment herein. As shown in FIG. 2A, the interface view 200 depicts a “patient” tab 202 and a “doctor” tab 204. The user of the health care platform 152 is allowed to select either the “patient” tab 202 or the “doctor” tab 204 to login as either the patient 106 or the health care professional 102 such as a doctor respectively.

FIG. 2B exemplarily illustrates a user interface view 206 depicted to a user of the health care platform 152 during authenticating login into the health care platform 152, according to an embodiment herein. In an embodiment, upon the user of the health care platform 152 being an already registered user, the user is allowed to enter his/her user name at a “user name” tab 208 and a corresponding password at a “password” tab 210 provided for entering the password, and then the user selects a “login” tab 212 to login to his/her account for authentication purposes. In one embodiment, upon the health care professional 102 being a new user of the health care platform 152, the health care professional 102 is allowed to register with the health care platform 152 by selecting “register” tab 214 of the user interface view 206 depicted in FIG. 2B.

FIG. 2C exemplarily illustrates a user interface view 216 depicted to a health care professional 102 to record/access a memo according to an embodiment herein. In an embodiment, the health care professional 102 records the memos by selecting a “start recording” tab 218. In one embodiment, the health care professional 102 is allowed to pause or resume the memo by selecting a “pause” tab 220 or a “resume” tab 222 respectively. Additionally, the health care professional is also allowed to access the recorded memo by selecting either “play back” tab 224, “stop playback” tab 226 or “view recording” tab 228 as depicted in the user interface view 216, according to an exemplary embodiment.

FIG. 2D exemplarily illustrates a user interface view 230 depicted to a health care professional 102 for saving a recorded memo according to an embodiment herein. In an embodiment, the health care professional 102 saves the memo by selecting a “submit” option 232 depicted in the user interface view 230 of the health care platform 152. The health care professional 102 may also be allowed to reset or delete the recorded memo, for example, the health care professional 102 may select a reset tab 234 to reset/delete the recorded memo. Upon submission of the memo, a user interface view 236 as in FIG. 2E is displayed to the health care professional 102. In an embodiment, upon submission of the recorded memo, a pop up message such as, for example pop up message 238 is displayed to the health care professional 102. The health care professional 102 accepts the pop up message 238 to successfully save the memo.

FIG. 2F exemplarily illustrates a user interface view 240 depicted to a health care professional 102 to view the recorded memo according to an embodiment herein. The health care professional 102 views the saved memo by selecting the “view recording” tab 242. In one embodiment, the health care professional 102 is allowed to play the saved memo.

FIG. 2G exemplarily illustrates a user interface view 244 of a list of recording memos according to an embodiment herein. In an embodiment, a list of saved memos can be viewed by selecting the “view recordings” tab 246 on top right corner of the user interface view 244. In an embodiment, the health care professional 102 is also allowed to individually view each of the recorded memos by selecting each individual memo tab such as memo tab.

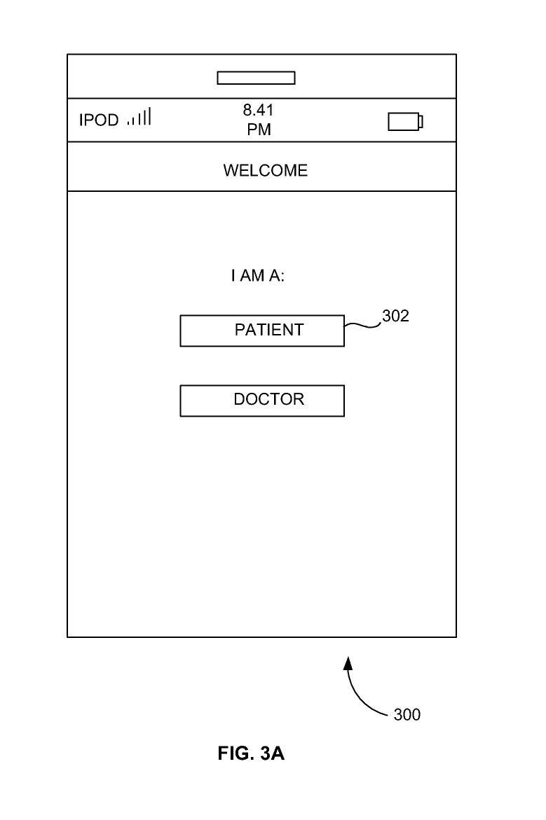

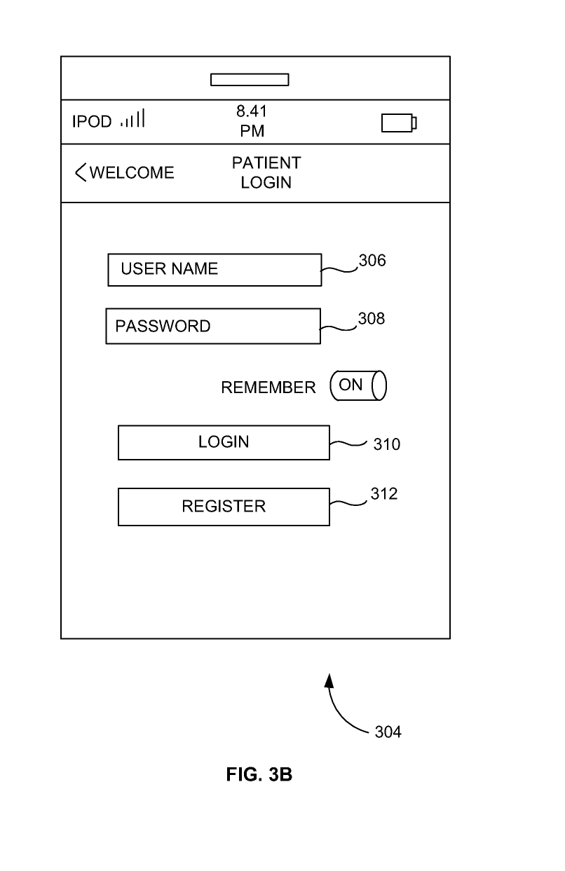

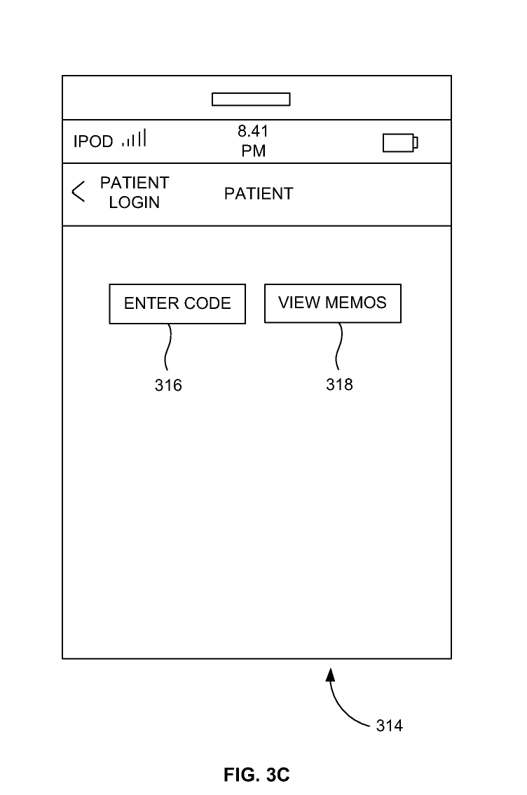

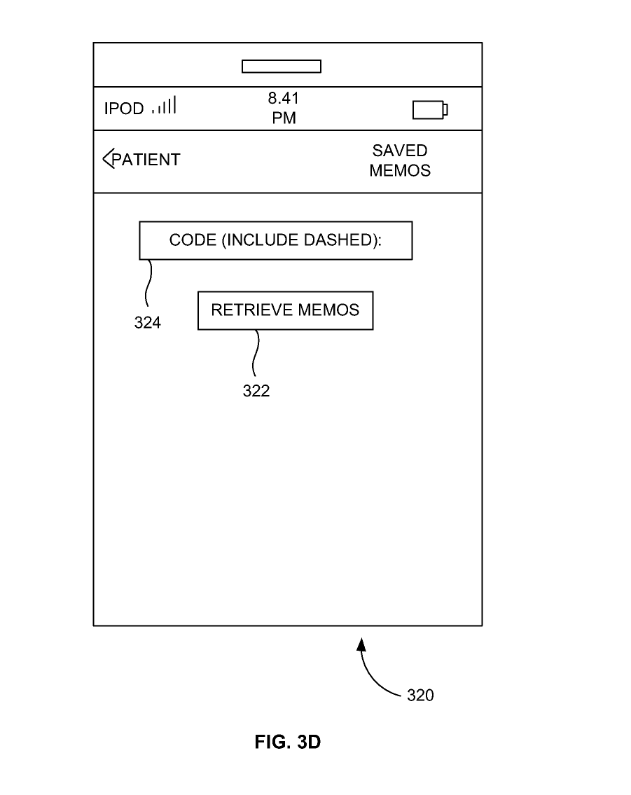

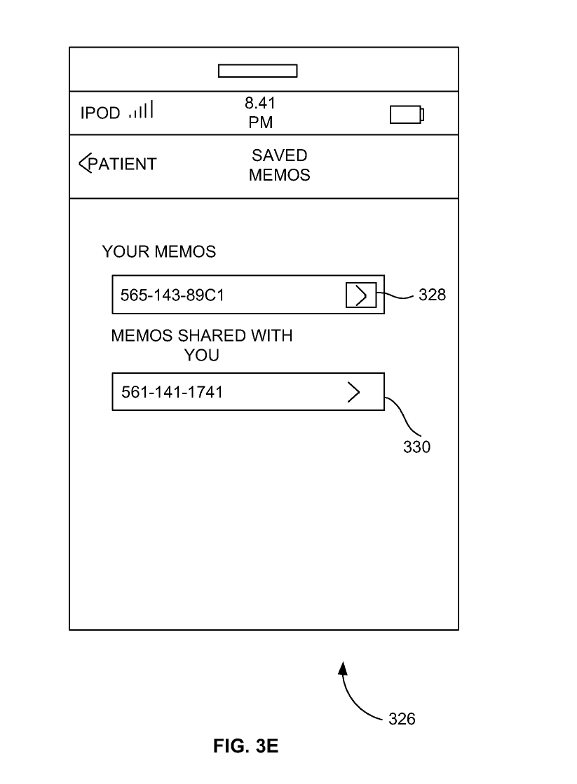

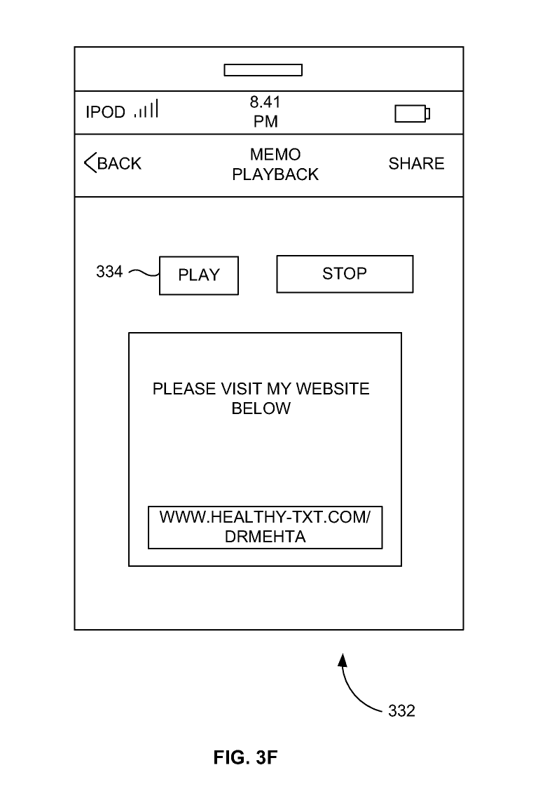

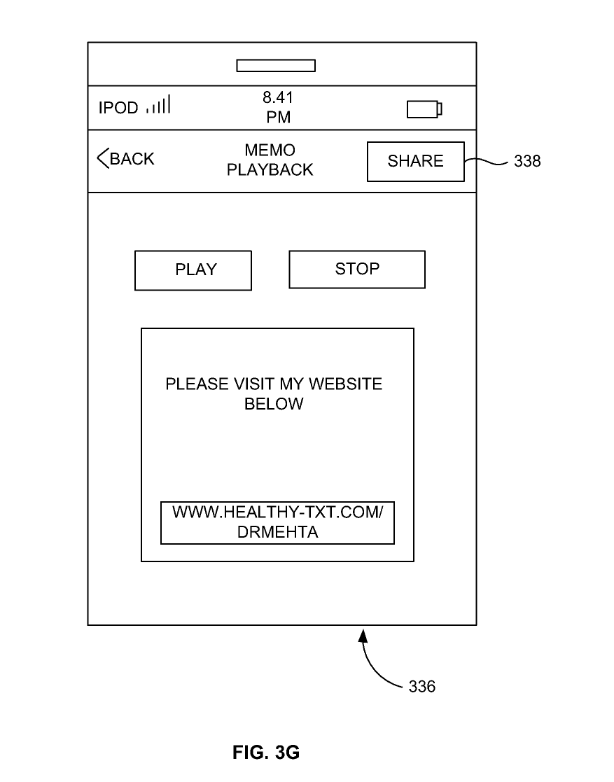

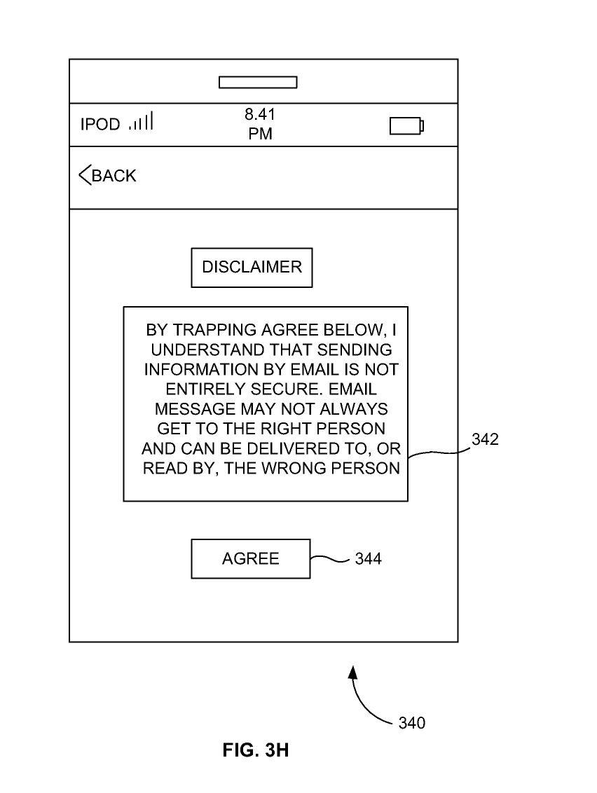

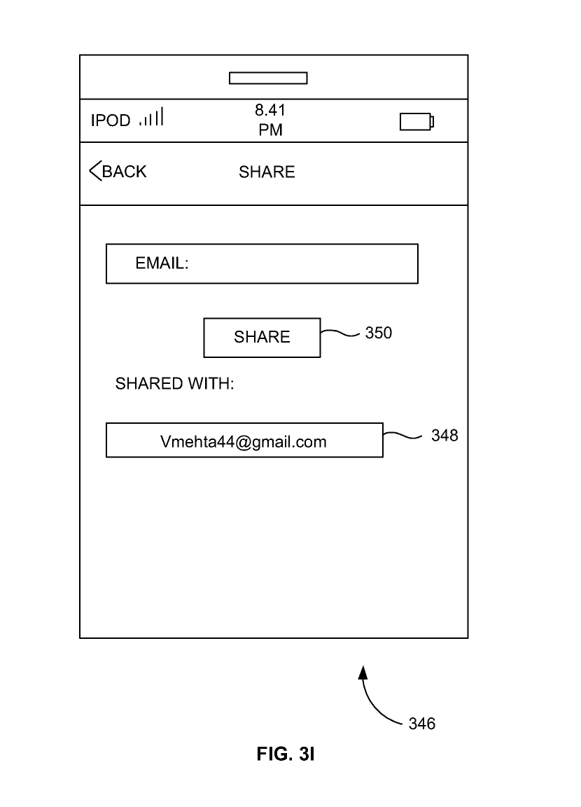

FIG. 3A exemplarily illustrates a user interface view 300 of a communication between a patient 106 and health care platform 152 according to an embodiment herein. In an embodiment, the patient 106 selects a “patient” tab 302 and enters into a login page.

FIG. 3B exemplarily illustrates a user interface view 304 depicted to a patient 106 during authenticating login into the health care platform 152, according to an embodiment herein. Upon the patient 106 being already registered with the health care platform 152, the patient 106 enters his/her user name and password in for example, a “user name” tab 306 and “password” tab 308 respectively and selects a “login” tab 310 to login his/her account. In one embodiment, upon the patient 106 being a new user, the patient 106 is allowed to register with the health care platform 152 by selecting a “register” tab 312 depicted in FIG. 3B. Upon login, interface view 314 of FIG. 3C is depicted to the patient to enter an identification code. The patient selects an “enter code” tab 316 to enter unique identification code associated with one or more recorded memos and authenticate to obtain access to the recorded memos stored in the memory 156 associated with the health care platform 152. Upon authentication, the patient 106 is allowed to access the recoded memos by selecting a “view memos” tab 318.

FIG. 3D exemplarily illustrates a user interface view 320 depicted to the patient 106 to retrieve a memo according to an embodiment herein. The patient 106 selects a “retrieve memos” tab 322 to retrieve the recorded memos subsequent to authentication. In an embodiment, the patient 106 enters the unique identification code associated with the memo he/she intends to retrieve by selecting a “code” tab 324. Upon entering the unique identification code, the patient 106 is allowed to select the “retrieve memos” tab 322 to access the corresponding memo/memos. FIG. 3E illustrates a user interface view 326 depicted to the patient 106 to view a list of memos according to an embodiment herein. In an embodiment, the patient 106 selects a drop down menu “your memos” 328 to view a list of memos and the health care platform 152 provides the patient 106 with a list of memos. In an embodiment, the patient 106 views a list of memos received from the health care professional 102 for the patient 106 by selecting a drop down menu “memos shared with you” 330 as depicted in FIG. 3E.

FIG. 3F illustrates a user interface view 332 depicted to the patient 106 to play/listen to a recoded memo according to an embodiment herein. The patient 106 selects a “play” tab 334 to listen to/view the recorded memo. FIG. 3G illustrates a user interface view 336 depicted to the patient 106 to share a memo with any individual according to an embodiment herein. The patient 106 shares the memo with an individual by selecting a “share” tab 338. Upon selection of the “share” 338 tab, the transmission unit 166 transmits the unique identification code to the individual to share the memo with the individual. In an embodiment, the patient 106 may share the memos with many individuals at once. In one embodiment, the individuals may include family members, friends, and the like. In an embodiment, upon selection of “share” tab 338 as in FIG. 3G, the patient 106 is displayed a user interface view 340 as in FIG. 3H is depicted to the patient 106. In an embodiment, a disclaimer such as disclaimer 342 may be displayed to the patient 106 and the patient may select “agree” tab 344 to agree to the disclaimer and send the memo to one or more individuals.

FIG. 3I exemplarily illustrates a user interface view 346 depicted to the patient 106 to enter an email id of an individual to share a memo with, according to an embodiment herein. The patient 106 enters the email id, for example “Vmehta44@gmail.com” in a “shared with” tab 348 and selects a “share” tab 350 to share the memo with the individual with the corresponding email id. In an embodiment, the individuals are able to view/listen to the memo when the individuals enter a unique identification code associated with the corresponding memos.

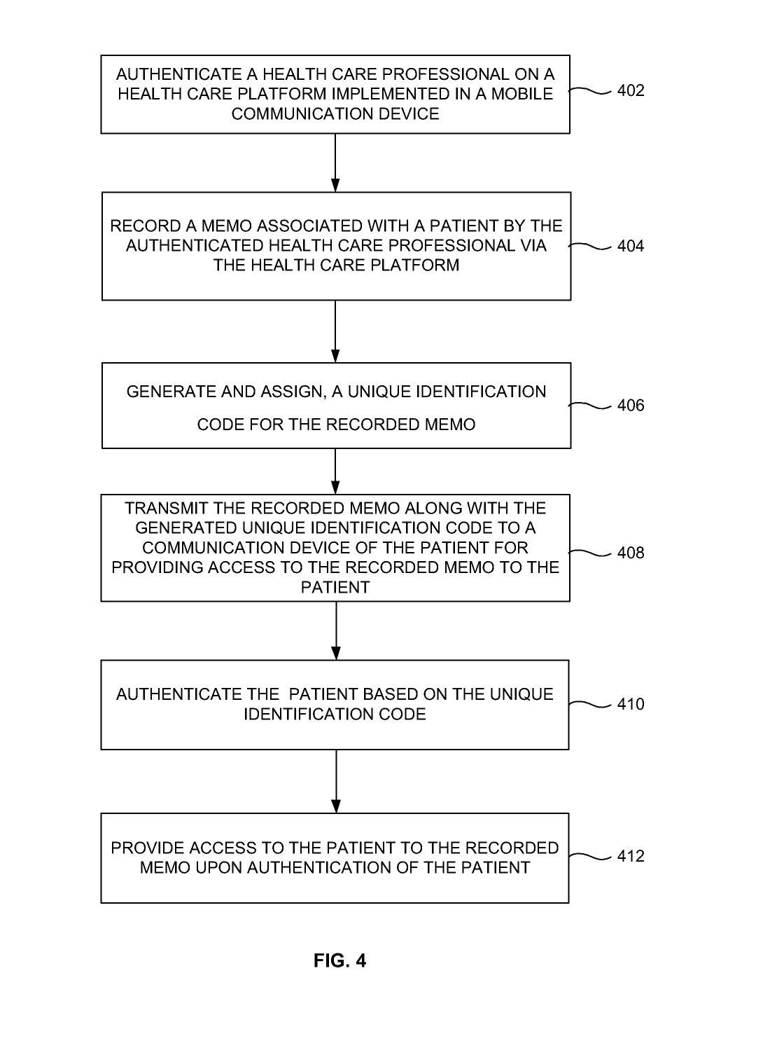

FIG. 4 is a flow diagram illustrating a method for enabling communication between a health care professional and a patient via the system 150 of FIG. 1B according to an embodiment herein. In an embodiment, at step 402, a health care professional 102 is authenticated on a health care platform 152 implemented in a mobile communication device 154. Examples of mobile communication device 154, may include, but is not limited to, and a laptop, a tablet, a notebook, a mobile phone, a smart phone, and a personal computer, and the like. The authentication of the health care professional 102 may be enabled via unique login information. The unique login information may include for example, a user id and password.

At step 404, a memo associated with the patient 106 is recorded by the authenticated health care professional 102 via the health care platform 152. The memo includes the health care related information associated with the patient 106. As used herein the term “memo” is construed as referring to data including any health care related information associated with a patient. The data may be for example, audio data or text data related to a health condition, prognosis, a post operational procedure, or any other general health related data. In an embodiment, the memo may be recorded based on a discussion of the health care professional 102 discusses with the patient 106 about one or more health related issues of the patient 108, such as health condition, prognosis, post operational procedure, medicine dosage, and the like. For example, a live conversation between the health care professional 102 and the patient 106 may be recorded and stored in a memory or memory associated with the mobile communication device. In another embodiment, the memo is recorded when the health care professional 102 is reviewing a patient file, in the presence or absence of the patient 106.

At step 406, the health care platform 152 generates and assigns a unique identification code for the recorded memo. The unique identification code may be used to authenticate a user of the health care platform to provide access to the recorded memo to authenticated users. In an embodiment, the patient 106 logs into the health care platform 152 as the patient 106 otherwise the patient 106 registers with the health care platform 152 when the patient 106 is a new user. The health care platform 152 generates and assigns the unique identification code for each memo. In an embodiment, the unique identification code may be assigned to a plurality of memos associated with one or more patients. When a patient logs into the health care platform 152, the health care platform 152 prompts the patient 106 to enter the unique identification code generated by the health care platform 152 that correlates to the memo or a series of the memos that the health care professional 102 recorded from the patient 106.

At step 408, the recorded memo is transmitted along with the generated unique identification code to a communication device of the patient 106 for providing access to the recorded memo to the patient 106. At step 410, the patient 106 is authenticated based on the unique identification code. In an embodiment, the transmission may be performed immediately after recording a memo associated with a patient or may be performed by the health care professional 102 at any instance of time when intending to share the memo with the patient 106 or any other individual. The unique identification code is used to authenticate access to the recorded memo. In an embodiment, the transmission of the unique identification code may be performed in the form of a text message or an electronic mail (Email). At step 412, the patient 106 is provided an access to the recorded memo upon authentication of the patient 106 at step 410. The patient 106 is provided an access to the recorded memos upon authentication based on the unique identification code.

The unique identification code may include, for example, a link, a code, a one-time password, and the like. In an embodiment, the patient 106 is authenticated via a unique login information. Upon being authenticated, the patient 106 or the health care professional 102 is allowed to view one or more recorded memos, listen to one or more recorded memos, delete one or more recorded memos, share one or more recorded memos, or share access to one or more recorded memos. The health care platform 152 allows the patient 106 to access the recorded memos at a later time and/or electronically share the memo with other individuals, such as friends and/or family. In an embodiment, health care professional 102 is able to share the one or more recordings to the patient 106 through the network 110 using the communication system 100. In an embodiment, the health care professional 102 sends the patient 106 an email or text message with the unique identification code to notify the patient 106 that a recording of memo is available and subsequently the patient 106 may enter into the health care platform 152 to access the memos.

In an embodiment, the memo is shared or access to memo is shared in the form of an email. In an embodiment, the memo is shared or access to memo is shared in the form of a message. The system 150 allows the patient 106 to share the memos by entering one or more electronic mail ids of one or more other individuals the patient 106 intends to share the recorded memo with. In an embodiment, the system 150 allows the patient 106 to play back the recorded memos to listen or view the recorded memos.

In an embodiment, the health care platform 152 sends an alert message to individuals when a unique identification code is shared with individuals. The individuals may be allowed to access the memos associated with the unique identification code. In an embodiment, the health care platform 152 also includes a user interface configured to enable communication and discussion between the patient 106 and health care professional regarding the recorded memo. The user interface is further configured to enable communication and discussion between the patient 106 and one or more other individuals authenticated via the user to obtain access to the recorded memo. In an embodiment, the communication may be enabled via a text based messaging system. In another embodiment, the text based messaging system acts like a communication portal. The individuals who received a shared memo are also allowed to communicate with the patient 106 via the user interface.

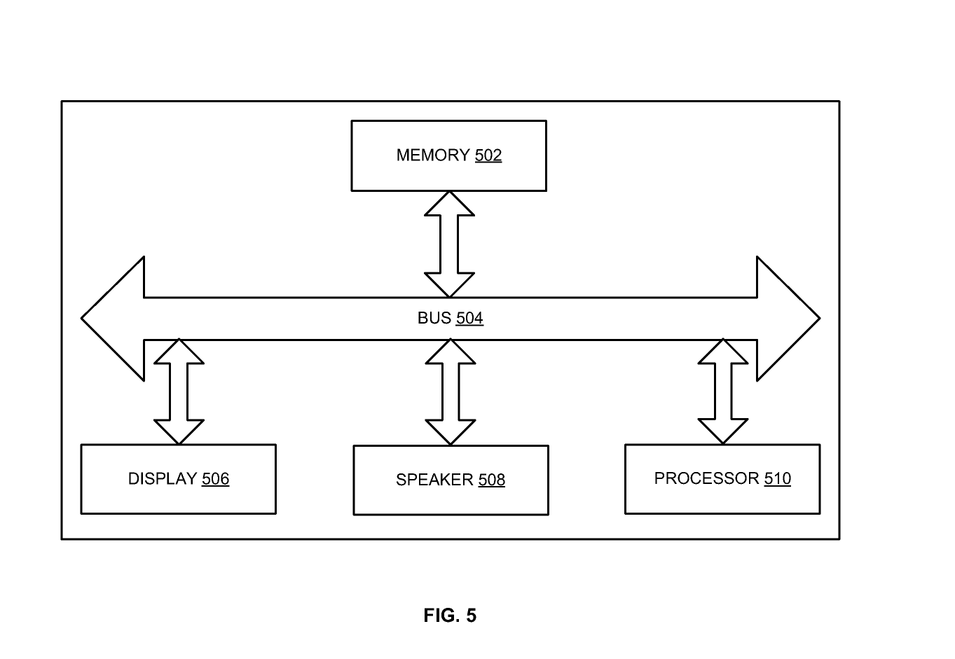

FIG. 5 illustrates an exploded view of a typical receiver device having an a memory 502 having a set of computer instructions, a bus 504, a display 506, a speaker 508, and a processor 510 capable of processing a set of instructions to perform any one or more of the methodologies herein, according to an embodiment herein. In one embodiment, the receiver may be the personal communication device. The processor 510 may also enable digital content to be consumed in the form of video for output via one or more displays 506 or audio for output via speaker and/or earphones 508. The processor 510 may also carry out the methods described herein and in accordance with the embodiments herein.

Digital content may also be stored in the memory 502 for future processing or consumption. The memory 502 may also store program specific information and/or service information (PSI/SI), including information about digital content (e.g., the detected information bits) available in the future or stored from the past. A user of the personal communication device may view this stored information on display 506 and select an item of for viewing, listening, or other uses via input, which may take the form of keypad, scroll, or other input device(s) or combinations thereof. When digital content is selected, the processor 510 may pass information. The content and PSI/SI may be passed among functions within the personal communication device using the bus 504.

The techniques provided by the embodiments herein may be implemented on an integrated circuit chip (not shown). For example, various components of the systems disclosed herein, such as processor 158, authentication unit 160, recording unit 162, identification unit 164, transmission unit 166, and the health care platform 152 disclosed herein may be implemented on an integrated circuitry. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein, such as system 150, processor 158, authentication unit 160, recording unit 162, identification unit 164, transmission unit 166, health care platform 152 may take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

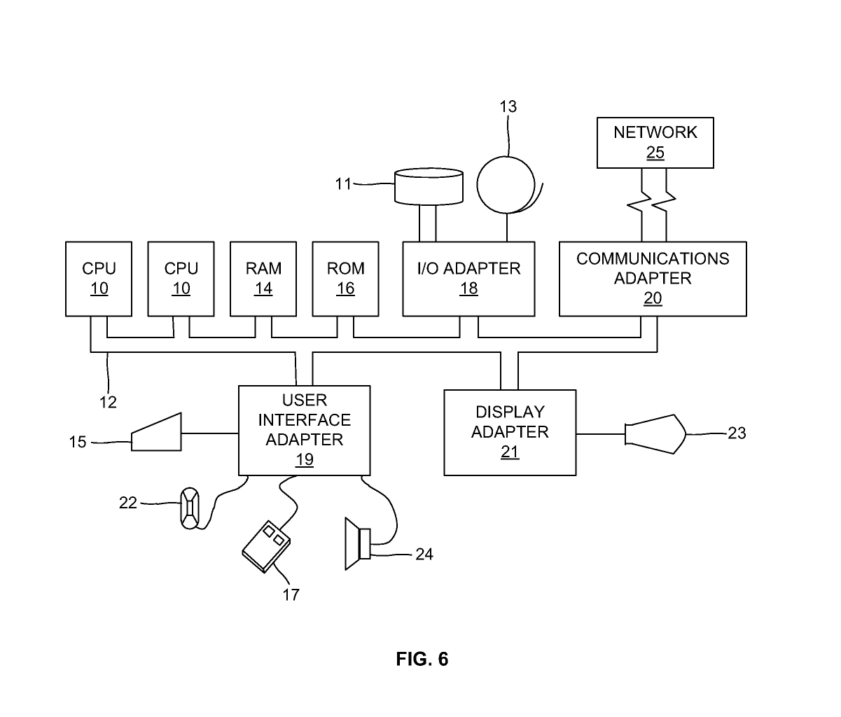

A representative hardware environment for practicing the embodiments herein is depicted in FIG. 6. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The healthcare platform 152 disclosed herein improves the compliance and outcomes. The health care professional 102 able to meet and/or provide medical suggestion to one or more patient at anytime through the healthcare communications system 100. The healthcare platform 152 minimizes the re-admission of the patient at the hospital. It improves the patent 106 satisfaction. The healthcare platform 152 improves the web reputation. The healthcare platform 152 educates the patient 106 about new procedures and services.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

We claim:

1. A system for enabling communication between a health care professional and a patient, the system comprising:
a mobile communication device; and
a health care platform communicatively associated with said mobile communication device, said health care platform comprising:
i) a memory; and
ii) a processor, said processor comprising:
an authentication unit for facilitating verifying of authentication of said health care professional;
a recording unit for recording a memo associated with a patient by said authenticated health care professional in said memory, wherein said memo comprises health care related information associated with said patient;
an identification unit for generating and assigning a unique identification code for said recorded memo; and
transmission unit for transmitting said recorded memo along with said generated unique identification code to a communication device of said patient for providing access to said recorded memo to said patient, wherein said system provides said patient an access to said recorded memos upon authentication of said patient based on said unique identification code.

2. The system of claim 1, wherein said authentication of said health care professional is enabled via a unique login information.

3. The system of claim 1, wherein said memo is generated based on a live discussion of said health care professional with said patient about one or more health related issues of said patient.

4. The system of claim 1, wherein said memo is generated based on a review of medical file of said patient by said health care professional in one of presence or absence of said patient.

5. The system of claim 1, wherein said system enables at least one of said patient or to share one or more recorded memos.

6. The system of claim 1, said transmission of at least one of said memo or said unique identification code is in the form of a message or an electronic mail.

7. The system of claim 1, wherein said system allows said patient to play back said recorded memos to listen or view said recorded memos.

8. The system of claim 1, wherein said authentication of said patient is via a unique login information.

9. The system of claim 1, wherein said system allows said patient to share the memos by entering one or more electronic mail ids of one or more other individuals said patient intends to share said recorded memo with.

10. The system of claim 1, wherein the health care platform further comprising a user interface configured to enable communication and discussion between said patient and said health care professional regarding said recorded memo, wherein said user interface is further configured to enable communication and discussion between said patient and one or more other individuals authenticated via said user to obtain access to said recorded memo.

11. A health care platform implemented in a mobile communication device, said health care platform comprising
i) a memory; and
ii) a processor, said processor comprising:
an authentication unit for facilitating verifying of authentication of a health care professional;
a recording unit for recording a memo associated with a patient by said authenticated health care professional in said memory;
an identification unit for generating and assigning a unique identification code for said recorded memo; and
transmission unit for transmitting said recorded memo along with said generated unique identification code to a communication device of said patient for providing access to said recorded memo to said patient, wherein said system provides said patient an access to said recorded memos upon authentication of said patient based on said unique identification code.

12. The health care platform of claim 11, wherein said memo is generated based on a discussion of said health care professional with said patient about one or more health related issues of said patient.

13. The health care platform of claim 11, wherein said memo is generated based on a review of medical file of said patient by said health care professional in one of presence or absence of said patient.

14. The health care platform of claim 11, wherein said system enables at least one of said patient or said health care professional to perform at least one of (i) view one or more recorded memos, (ii) listen to one or more recorded memos, (iv) delete one or more recorded memos, (v) share one or more recorded memos, or (vi) share access to one or more recorded memos.

15. A method for enabling communication between a health care professional and a patient, the method comprising:
authenticating a health care professional on a health care platform implemented in a mobile communication device;
recording a memo associated with a patient by said authenticated health care professional via said health care platform, wherein said memo comprises health care related information associated with said patient;
generating a unique identification code for said recorded memo;
assigning the unique identification code for said recorded memo
transmitting said recorded memo along with said generated unique identification code to a communication device of said patient for providing access to said recorded memo to said patient;
authenticating said patient based on said unique identification code; and
providing access to said patient to said recorded memo upon authentication of said patient.

16. The method of claim 15, wherein said authentication of said health care professional is enabled via a unique login information.

17. The method of claim 15, wherein said memo is generated based on a discussion of said health care professional with said patient about one or more health related issues of said patient.

18. The method of claim 15, wherein said memo is generated based on a review of medical file of said patient by said health care professional in one of presence or absence of said patient.

19. The method of claim 15, wherein said system enables at least one of said patient or said health care professional to perform at least one of (i) view one or more recorded memos, (ii) listen to one or more recorded memos, (iv) delete one or more recorded memos, (v) share one or more recorded memos, or (vi) share access to one or more recorded memos.

20. The method of claim 15, further comprising:
enabling via said health care platform:
communication and discussion between said patient and said health care professional regarding said recorded memo; and
communication and discussion between said patient and one or more other individuals authenticated via said patient to obtain access to said recorded memo.
